(19) United States
(12) Patent Application Publication
(10) Pub. No.: US 2024/0403775 A1
(43) Pub. Date: Dec. 5, 2024

(54) PREDICTING WELL PERFORMANCE FROM UNCONVENTIONAL RESERVOIRS WITH THE IMPROVED MACHINE LEARNING METHOD FOR A SMALL TRAINING DATA SET BY INCORPORATING A SIMPLE PHYSICS CONSTRAIN

(71) Applicant: ARAMCO SERVICES COMPANY, Houston, TX (US)

(72) Inventors: Jilin Zhang, Houston, TX (US); Hui-Hai Liu, Katy, TX (US); Feng Liang, Cypress, TX (US); Moemen Abdelrahman, Dhahran (SA)

(73) Assignees: ARAMCO SERVICES COMPANY, Houston, TX (US); SAUDI ARABIAN OIL COMPANY, Dhahran (SA)

(21) Appl. No.: 18/325,777

(22) Filed: May 30, 2023

(51) Int. Cl. G06Q 10/0637; G06Q 50/02

(52) U.S. Cl. CPC G06Q 10/06375; G06Q 50/02

(57) ABSTRACT

A method and a system for predicting well production of a reservoir using machine learning models and algorithms is disclosed. The method includes obtaining a training data set for training a machine learning (ML) model and selecting an artificial neural network model structure, the model structure including a number of layers and a number of nodes of each layer. Further, the method includes generating a plurality of individually trained ML models and calculating a model performance of each trained model by evaluating a difference between a model prediction and a well performance data. The plurality of top-ranked individually trained ML models is constrained using one or multiple known physical rules. A plurality of individual predicted well production data is generated using the geological, the completion, and the petrophysical data of interest and a final predicted well production data is generating based on the plurality of individual predicted well production data.

### BACKGROUND

Machine learning (ML) methods have been widely used in predicting the well performance in the petroleum industry, with the prediction of the well performance being an important factor in the development and economic evaluation of the unconventional resources. The ML method normally involves setting up a ML model structure or algorithm, training the model using a large amount of data to determine model parameters by matching the predicted results and the known results from the training data set, and making model predictions.

Prediction of well performance in unconventional reservoirs has been critical for the development of unconventional resources. The machine learning (ML) method has been used for predicting well productions in the oil and gas industry, and generally requires a significant amount of data for the training purpose. A small training data set does not allow the machine learning method to generate optimal results. Model training is a process to determine unknown model parameters by matching the model results with observations. The trained model can then be used for predictions. However, it is always desirable to incorporate the domain knowledge, such as physics constrains, to constrain the model training given the small size of the training data set.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to for predicting well production of a reservoir. The method includes obtaining a training data set for training a machine learning (ML) model, wherein the ML model generates predicted well production data based on geological, completion, and petrophysical data of interest, wherein the training data set comprises historical well production data and corresponding geological, completion, and petrophysical data and selecting an artificial neural network (ANN) model structure, the model structure including a number of layers and a number of nodes of each layer. Further, the method includes generating, using an ML algorithm applied to the training data set, a plurality of individually trained ML models, wherein each individually trained ML model is generated based on one of a plurality sets of initial model parameters and selecting the plurality of individually trained ML models based on loss values of the training data set and calculating a model performance of each trained model by evaluating a difference between a model prediction and a well performance data. Additionally, an order of individually trained ML models is determined based on both the loss value of the training data set and the loss values of a validation data set and selecting, based on the order, a plurality of top-ranked individually trained ML models and the plurality of top-ranked individually trained ML models are constrained using one or multiple known physical rules and selecting a subset of the top-ranked individually trained ML models that can be based on a sensitivity analysis or other types of analyzes including a perforated well length rule. Further, the method includes generating, using the geological, the completion, and the petrophysical data of interest as input to the constrained models, a plurality of individual predicted well production data and generating, based on the plurality of individual predicted well production data, a final predicted well production data.

In general, in one aspect, embodiments disclosed herein relate to a non-transitory computer readable medium storing a set of instructions executable by a computer processor for predicting well production of a reservoir. The set of instructions includes the functionality for obtaining a training data set for training a machine learning (ML) model, wherein the ML model generates predicted well production data based on geological, completion, and petrophysical data of interest, wherein the training data set comprises historical well production data and corresponding geological, completion, and petrophysical data and selecting an artificial neural network (ANN) model structure, the model structure including a number of layers and a number of nodes of each layer. Further, a plurality of individually trained ML models is generated, wherein each individually trained ML model is generated based on one of a plurality sets of initial model parameters and the plurality of individually trained ML models are selected based on loss values of the training data set and calculating a model performance of each trained model by evaluating a difference between a model prediction and a well performance data. Additionally, an order of individually trained ML models is determined based on both the loss value of the training data set and the loss values of a validation data set and selecting, based on the order, a plurality of top-ranked individually trained ML models and the plurality of top-ranked individually trained ML models are constrained using one or multiple known physical rules and selecting a subset of the top-ranked individually trained ML models that can be based on a sensitivity analysis or other types of analyzes including a perforated well length rule. Further, a plurality of individual predicted well production data are generating, using the geological, the completion, and the petrophysical data of interest as input to the constrained models, and a final predicted well production data is generated, based on the plurality of individual predicted well production data.

In general, in one aspect, embodiments disclosed herein relate to a system including a tight reservoir, a data repository storing a training data set for training a machine learning (ML) model, wherein the training data set comprises historical well production data and corresponding geological, completion, and petrophysical data, and an analysis and modeling engine. Further, the analysis and modeling engine comprises functionality for obtaining a training data set for training a machine learning (ML) model, wherein the ML model generates predicted well production data based on geological, completion, and petrophysical data of interest, wherein the training data set comprises historical well production data and corresponding geological, completion, and petrophysical data and selecting an artificial neural network (ANN) model structure, the model structure including a number of layers and a number of nodes of each layer. Further, a plurality of individually trained ML models is generated, wherein each individually trained ML model is generated based on one of a plurality sets of initial model parameters and the plurality of individually trained ML models are selected based on loss values of the training data set and calculating a model performance of each trained model by evaluating a difference between a model prediction and a well performance data. Additionally, an order of individually trained ML models is determined based on both the loss value of the training data set and the loss values of a validation data set and selecting, based on the order, a plurality of top-ranked individually trained ML models and the plurality of top-ranked individually trained ML models are constrained using one or multiple known physical rules and selecting a subset of the top-ranked individually trained ML models that can be based on a sensitivity analysis or other types of analyzes including a perforated well length rule. Further, a plurality of individual predicted well production data are generating, using the geological, the completion, and the petrophysical data of interest as input to the constrained models, and a final predicted well production data is generated, based on the plurality of individual predicted well production data.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a system in accordance with one or more embodiments.

FIG. 3 shows a flowchart in accordance with one or more embodiments.

FIGS. 4A, 4B, 4C, 4D show an example in accordance with one or more embodiments.

FIG. 5 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of the invention provide a method, a system, and a non-transitory computer readable medium for predicting well production of a reservoir using machine learning models and algorithms structured based on an artificial neural network. In one or more embodiments, a physics constrain is employed that is relatively simple and easy to implement. More specifically, if all the other geological, petrophysical, and completion (in terms of value per foot of the well length) parameters remain the same, a longer perforated well length should give a better well performance, because the well is able to access a larger zone of reservoir for hydrocarbon production. Rules like the following perforated well length rule, “the longer the perforated well length the same or the larger the production”, can be used to further select the final trained models, i.e., to filter out the trained models that don't comply with this rule. Thus, to predict well production from a reservoir, a final model prediction is obtained by averaging prediction of those trained models that meet the above physics constrains, or physical rules.

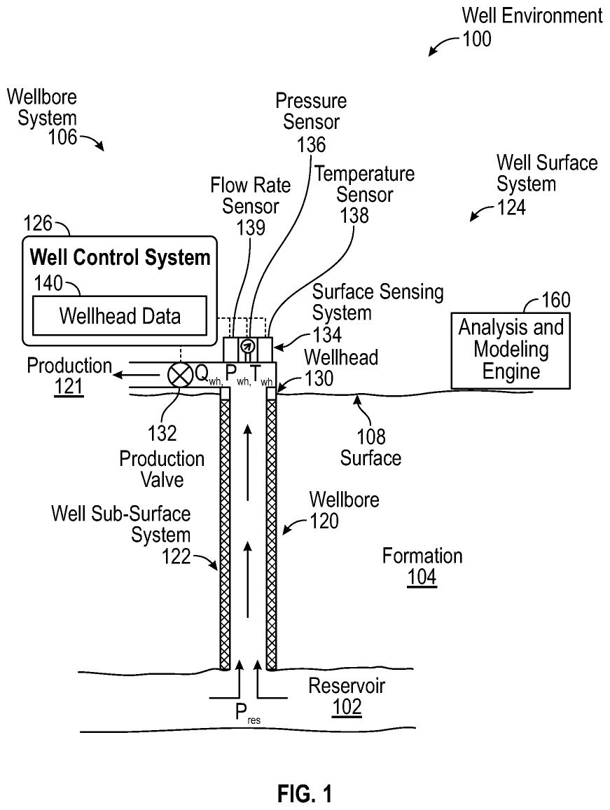

FIG. 1 shows a schematic diagram in accordance with one or more embodiments. More specifically, FIG. 1 illustrates a well environment (100) that includes a hydrocarbon reservoir (“reservoir”) (102) located in a subsurface formation (“formation”) (104) and a well system (106). The formation (104) may include a porous formation that resides underground, beneath the Earth's surface (“surface”) (108). In the case of the well system (106) being a hydrocarbon well, the reservoir (102) may include a portion of the formation (104). The formation (104) and the reservoir (102) may include different layers (referred to as subterranean intervals or geological intervals) of rock having varying characteristics, such as varying degrees of permeability, porosity, capillary pressure, and resistivity. In other words, a subterranean interval is a layer of rock having consistent permeability, porosity, capillary pressure, resistivity, and/or other characteristics that set it apart from another layer of rock. For example, the reservoir (102) may be an unconventional reservoir or tight reservoir in which fractured horizontal wells are needed for the production. In the case of the well system (106) being operated as a production well, the well system (106) may facilitate the extraction of hydrocarbons (or “production”) from the reservoir (102).

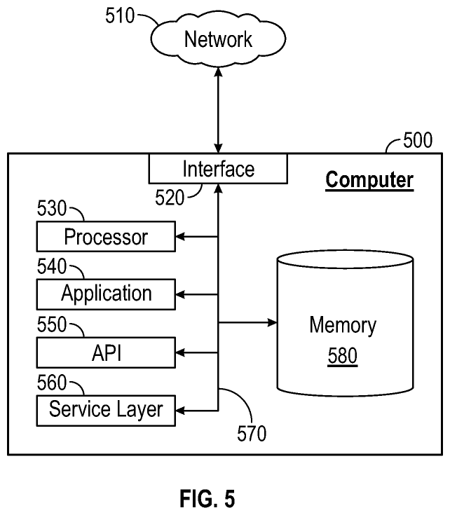

In some embodiments, the well system (106) includes a wellbore (120), a well sub-surface system (122), a well surface system (124), and a well control system (“control system”) (126). The control system (126) may control various operations of the well system (106), such as well production operations, well completion operations, well maintenance operations, and reservoir monitoring, assessment and development operations. In some embodiments, the control system (126) includes a computer system that is the same as or similar to that of computer system (500) described below in FIG. 5 and the accompanying description.

The wellbore (120) may include a bored hole that extends from the surface (108) into a target zone (i.e., a subterranean interval) of the formation (104), such as the reservoir (102). An upper end of the wellbore (120), terminating at or near the surface (108), may be referred to as the “up-hole” end of the wellbore (120), and a lower end of the wellbore, terminating in the formation (104), may be referred to as the “down-hole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the formation (104) or the reservoir (102) during injection operations, or the communication of monitoring devices (e.g., logging tools) into the formation (104) or the reservoir (102) during monitoring operations (e.g., during in situ logging operations). For example, the logging tools may include logging-while-drilling tool or logging-while-tripping tool for obtaining downhole logs.

In some embodiments, during operation of the well system (106), the control system (126) collects and records wellhead data (140) for the well system (106). The wellhead data (140) may include, for example, a record of measurements of wellhead pressure (P_{wh}) (e.g., including flowing wellhead pressure), wellhead temperature (T_{wh}) (e.g., including flowing wellhead temperature), wellhead production rate (Q_{wh}) over some or all of the life of the well (106), and water cut data. In some embodiments, the measurements are recorded in real-time, and are available for review or use within seconds, minutes, or hours of the condition being sensed (e.g., the measurements are available within 1 hour of the condition being sensed). In such an embodiment, the wellhead data (140) may be referred to as “real-time” wellhead data (140). Real-time wellhead data (140) may enable an operator of the well (106) to assess a relatively current state of the well system (106) and make real-time decisions regarding development of the well system (106) and the reservoir (102), such as on-demand adjustments in regulation of production flow from the well.

In some embodiments, the well sub-surface system (122) includes casing installed in the wellbore (120). For example, the wellbore (120) may have a cased portion and an uncased (or “open-hole”) portion. The cased portion may include a portion of the wellbore having casing (e.g., casing pipe and casing cement) disposed therein. The uncased portion may include a portion of the wellbore not having casing disposed therein. In embodiments having a casing, the casing defines a central passage that provides a conduit for the transport of tools and substances through the wellbore (120). For example, the central passage may provide a conduit for lowering logging tools into the wellbore (120), a conduit for the flow of production (121) (e.g., oil and gas) from the reservoir (102) to the surface (108), or a conduit for the flow of injection substances (e.g., water) from the surface (108) into the formation (104). In some embodiments, the well sub-surface system (122) includes production tubing installed in the wellbore (120). The production tubing may provide a conduit for the transport of tools and substances through the wellbore (120). The production tubing may, for example, be disposed inside casing. In such an embodiment, the production tubing may provide a conduit for some or all of the production (121) (e.g., oil and gas) passing through the wellbore (120) and the casing.

In some embodiments, the well surface system (124) includes a wellhead (130). The wellhead (130) may include a rigid structure installed at the “up-hole” end of the wellbore (120), at or near where the wellbore (120) terminates at the Earth's surface (108). The wellhead (130) may include structures (called “wellhead casing hanger” for casing and “tubing hanger” for production tubing) for supporting (or “hanging”) casing and production tubing extending into the wellbore (120). Production (121) may flow through the wellhead (130), after exiting the wellbore (120) and the well sub-surface system (122), including, for example, the casing and the production tubing. In some embodiments, the well surface system (124) includes flow regulating devices that are operable to control the flow of substances into and out of the wellbore (120). For example, the well surface system (124) may include one or more production valves (132) that are operable to control the flow of production (121). For example, a production valve (132) may be fully opened to enable unrestricted flow of production (121) from the wellbore (120), the production valve (132) may be partially opened to partially restrict (or “throttle”) the flow of production (121) from the wellbore (120), and production valve (132) may be fully closed to fully restrict (or “block”) the flow of production (121) from the wellbore (120), and through the well surface system (124).

In some embodiments, the wellhead (130) includes a choke assembly. For example, the choke assembly may include hardware with functionality for opening and closing the fluid flow through pipes in the well system (106). Likewise, the choke assembly may include a pipe manifold that may lower the pressure of fluid traversing the wellhead. As such, the choke assembly may include set of high pressure valves and at least two chokes. These chokes may be fixed or adjustable or a mix of both. Redundancy may be provided so that if one choke has to be taken out of service, the flow can be directed through another choke. In some embodiments, pressure valves and chokes are communicatively coupled to the well control system (126). Accordingly, a well control system (126) may obtain wellhead data regarding the choke assembly as well as transmit one or more commands to components within the choke assembly in order to adjust one or more choke assembly parameters.

Keeping with FIG. 1, in some embodiments, the well surface system (124) includes a surface sensing system (134). The surface sensing system (134) may include sensors for sensing characteristics of substances, including production (121), passing through or otherwise located in the well surface system (124). The characteristics may include, for example, pressure, temperature, and flow rate of production (121) flowing through the wellhead (130), or other conduits of the well surface system (124), after exiting the wellbore (120).

In some embodiments, the surface sensing system (134) includes a surface pressure sensor (136) operable to sense the pressure of production (121) flowing through the well surface system (124), after it exits the wellbore (120). The surface pressure sensor (136) may include, for example, a wellhead pressure sensor that senses a pressure of production (121) flowing through or otherwise located in the wellhead (130). In some embodiments, the surface sensing system (134) includes a surface temperature sensor (138) operable to sense the temperature of production (121) flowing through the well surface system (124), after it exits the wellbore (120). The surface temperature sensor (138) may include, for example, a wellhead temperature sensor that senses a temperature of production (121) flowing through or otherwise located in the wellhead (130), referred to as “wellhead temperature” (T_{wh}). In some embodiments, the surface sensing system (134) includes a flow rate sensor (139) operable to sense the flow rate of production (121) flowing through the well surface system (124), after it exits the wellbore (120). The flow rate sensor (139) may include hardware that senses a flow rate of production (121) (Q_{wh}) passing through the wellhead (130).

Prior to completing the well system (106) or for identifying candidate locations to drill a new well, hydrocarbon reserves and corresponding production flow rate may be estimated to evaluate the economic potential of completing the formation drilling to access an oil or gas reservoir, such as the reservoir (102). Estimating the hydrocarbon reserve and corresponding production flow rate of a tight reservoir is particularly important due to the expense of hydraulic fracturing operations necessary to produce hydrocarbons. The well system (106) further includes an analysis and modeling engine (160). For example, the analysis and modeling engine (160) may include hardware and/or software with functionality to analyze historical well production data and corresponding historical geological, completion, and petrophysical data of the reservoir (102) and/or update one or more reservoir models and corresponding hydrocarbon reserve and production flow rate estimates of the reservoir (102).

While a single production well is depicted in FIG. 1, multiple wells may exist in the formation (104) to access the reservoir (102) or other similar reservoirs in neighboring region(s). While the analysis and modeling engine (160) is shown at a well site in FIG. 1, those skilled in the art will appreciate that the analysis and modeling engine (160) may also be remotely located away from well site.

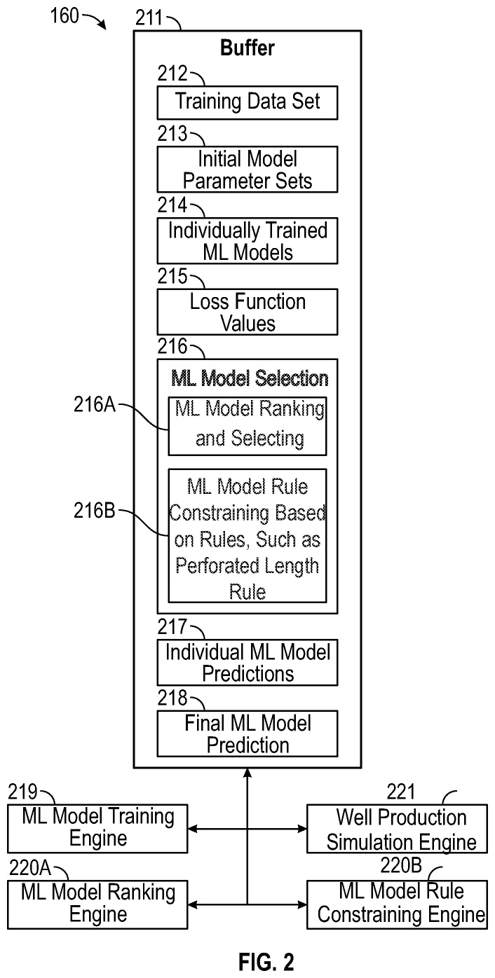

Turning to FIG. 2, FIG. 2 shows a schematic diagram in accordance with one or more embodiments. Specifically, FIG. 2 illustrates details of the analysis and modeling engine (160) depicted in FIG. 1 above. In one or more embodiments, one or more of the modules and/or elements shown in FIG. 2 may be omitted, repeated, and/or substituted. Accordingly, embodiments of the invention should not be considered limited to the specific arrangements of modules and/or elements shown in FIG. 2. In one or more embodiments of the invention, although not shown in FIG. 2, the analysis and modeling engine (160) may include a computer system that is similar to the computer system (500) described below with regard to FIG. 5 and the accompanying description.

As shown in FIG. 2, the analysis and modeling engine (160) has multiple components, including, for example, a buffer (211), an ML model training engine (219), an ML model ranking engine (220A), a ML model rule selecting engine (220B) and a well production simulation engine (221). Each of these components (211, 219, 220, 221) may be implemented in hardware (i.e., circuitry), software, or any combination thereof. Further, each of these components (211, 219, 220, 221) may be located on the same computing device (e.g., personal computer (PC), laptop, tablet PC, smart phone, multifunction printer, kiosk, server, etc.) or on different computing devices connected by a network of any size having wired and/or wireless segments. In one or more embodiments, these components may be implemented using the computing system (500) described below in reference to FIG. 5. Each of these components is discussed below.

In one or more embodiments of the invention, the buffer (211) is configured to store data such as a training data set (212), initial model parameter sets (213), individually trained ML models (214), a loss function values (215), an ML model ranking (216A), an ML Rule constraining (216B), individual ML model predictions (217), and a final ML model prediction (218). Training data set (212) are a collection of geological, completion, petrophysical and production data from a number of wells in the reservoir (102) or other similar reservoirs in neighboring region(s). For example, the geological data may include thickness of producing formation, the petrophysical data may include vertically averaged porosity, water saturation and total carbon content (TOC)), the completion data may include number of stages, number of clusters per stage, total perforated well length, amount of proppant per perforated well length, amount of slurry per perforated well length, and the ratio of amount of 100 mesh proppant to the total amount of proppant, and the production data may include flow rate. The historical geological, completion, petrophysical and production data may be collected continuously, intermittently, automatically or in response to user commands, over one or more production periods, and/or according to other data collection schedules.

The initial model parameter sets (213) are individual sets of initial model parameters that are randomly generated and used as unknown parameters for machine learning algorithms to train a mathematical model representing the well production. The training of the machine learning model is a process to determine these parameters by optimizing the match between model prediction and the known data. The machine learning algorithms may be supervised or unsupervised, and may include neural network algorithms, Naive Bayes, Decision Tree, vector-based algorithms such as Support Vector Machines, or regression-based algorithms such as linear regression, unsupervised ML algorithms, etc. For example, the mathematical model may be an artificial neuron network (ANN) where the model parameters correspond to weights associated with connections in the ANN.

The individually trained ML models (214) are a collection of mathematical models that are used to generate predicted well production data based on geological, completion, and petrophysical data of interest. Each individually trained ML model is trained using one of the initial model parameter sets (213) as the initial guesses for parameters of machine learning algorithms. In other words, the final model parameters in each individually trained ML model are trained by the machine learning algorithms using one of the initial model parameter sets (213) as the initial guesses for the parameters.

The loss function values (215) are a set of loss function values each representing a measure of modeling accuracy of a corresponding individually trained ML model. For example, the measure of modeling accuracy may be computed as a mean squared error of predicted production data with respect to historical production data.

The ML model selection (216) involves two substeps: ML model ranking and selecting (216A) and ML Model Rule constraining (216B), the former determining an order of the individually trained ML models (214) and select these that have the less loss function values for the validation set after the loss function values for the training set meet some preset criteria and the latter further selects the models that conform preselected rules, such as the perforated well length rule, “the longer the perforated well length the same or the more production (when other factors are forced the same)”. In particular, each individually trained ML model is assigned a rank according to the corresponding loss function value that measures the difference between the model prediction and the known value for the validation data set that is not used for training after the training for the training set of data reaches some predetermined criteria. In other words, more accurate individually trained ML models are assigned higher ranks and kept in the ML model selection (216A) and more conforming-to-known-rules-of-physics/common-sense ML models are kept (216B).

The individual ML model predictions (217) are well production predictions (e.g., predicted flow rates) each generated using a corresponding individually trained ML model.

The final ML model prediction (218) is an aggregate result (e.g., mathematical average) of the individual ML model predictions (217) from selected higher ranked individually trained ML models.

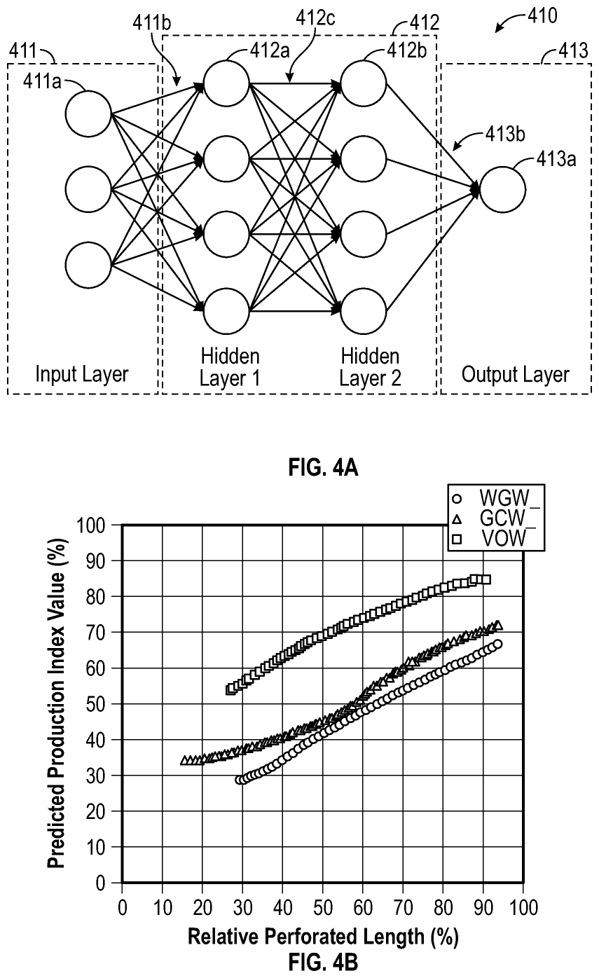

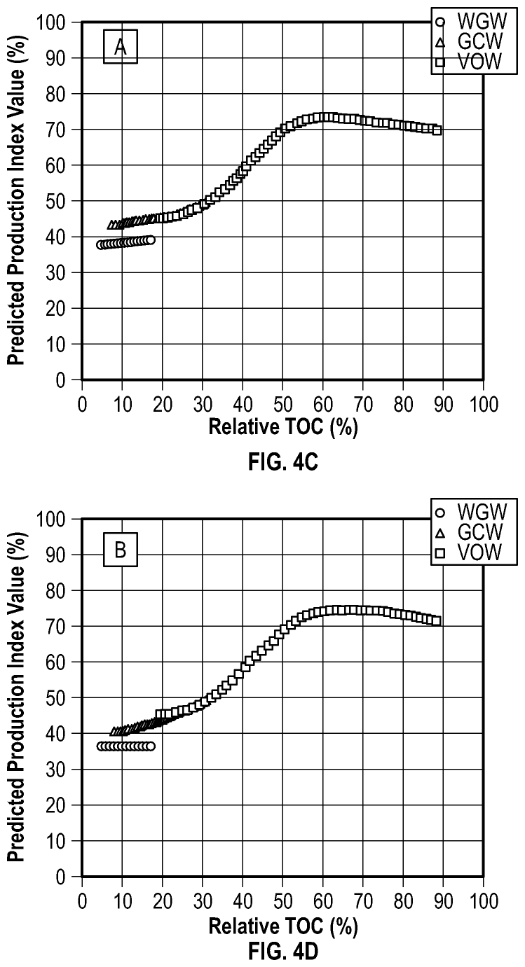

In one or more embodiments of the invention, the ML model training engine (219) is configured to generate the individually trained ML models (214) based on the training data set (212) and the initial model parameter sets (213). In one or more embodiments, the ML model ranking engine (220A) is configured to compute the loss function values (215) and generate the ML model ranking (216A) based on the loss function values (215) and the ML model rule constraining engine (220B) is configured to compute a series production with changing perforated well length while holding other variables constant and select these models that conform to the perforated well length rule. In one or more embodiments, the well production simulation engine (221) is configured to generate the individual ML model predictions (217) and the final ML model prediction (218) using the individually trained ML models (214) and according to the ML model ranking (216A) and ML Model Rule Constraining (216B). In one or more embodiments, the ML model training engine (219), the ML model ranking engine (220A), the ML Model Rule Constraining engine (220B) and the well production simulation engine (221) perform the functions described above using the workflow described in reference to FIG. 2 below. An example of performing the method workflow using the ML model training engine (219), the ML model ranking engine (220A), the ML Model Rule Constraining engine (220B), and the well production simulation engine (221) is described in reference to FIGS. 4A-4D below.

Although the analysis and modeling engine (160) is shown as having four components (219, 220A, 220B, 221), in one or more embodiments of the invention, the analysis and modeling engine (216A) and the ML Model Rule constraining (216B) may have more or fewer components, i.e., more than one rules to follow. Furthermore, the functions of each component described above may be split across components or combined in a single component. Further still, each component (219, 220A, 220B, 221) may be utilized multiple times to carry out an iterative operation.

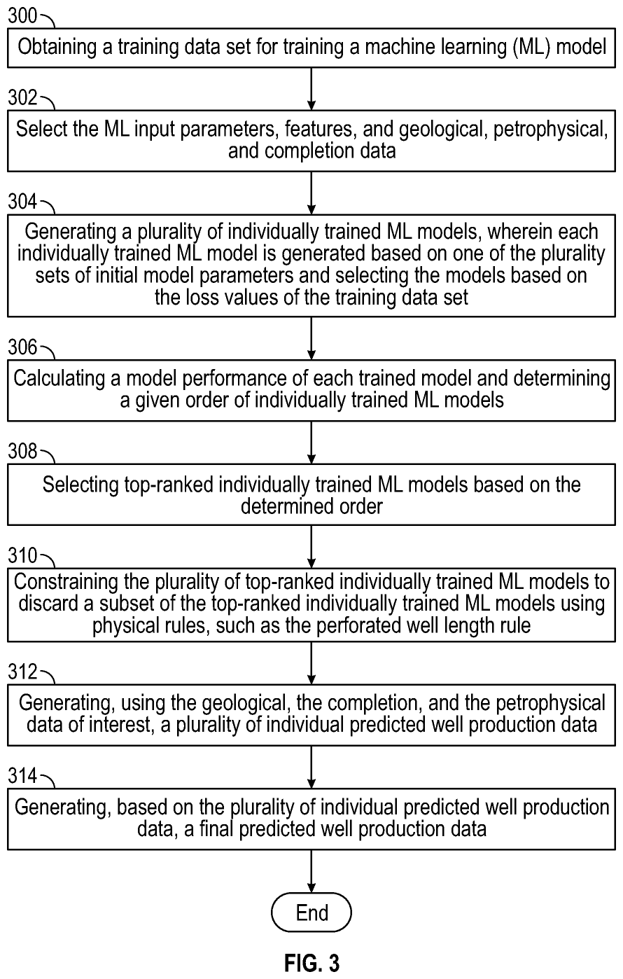

FIG. 3 shows a flowchart in accordance with one or more embodiments. One or more blocks in FIG. 3 may be performed using one or more components as described in FIGS. 1 and 2. While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Initially in Block 300, a training data set is obtained for training a machine learning (ML) model, which generates predicted well production data based on geological, completion, and petrophysical data of interest. The training data set includes historical well production data and corresponding geological, completion, and petrophysical data. In one or more embodiments, the reservoir is a tight reservoir and the training data set includes historical well production data and corresponding geological, completion, and petrophysical data that are obtained from a small number (e.g., less than 100) of production wells of the reservoir. Additionally, multiple sets of initial model parameters of the ML model may be generated. In one or more embodiments, each set of initial model parameters includes randomly generated model parameter values.

In Block 302, ML input parameters, features, and geological, petrophysical, and completion data are selected. The input parameters and features may include, at least, pressure/volume/temperature (PVT) Window, resource density, TOC, water saturation, perforated well length, proppant per foot, and proppant size ratio, which is defined as the ratio of amount of 100 mesh sand to the total amount of proppant. The PVT window includes wet gas window (WGW), gas condensate window (GCW) and volatile oil window (VOW). Further, the resource density is defined as the formation net thickness multiplied by porosity and by hydrocarbon saturation.

Further, the data includes geological information such as a thickness of producing formation, petrophysical properties such as a vertically averaged porosity, a water saturation, and a total carbon content, and completion parameters for hydraulic such as a number of stages, a number of clusters per stage, a total perforated well length, amount of proppant per perforated well length, amount of slurry per perforated well length, and a ratio of amount of 100 mesh proppant to the total amount of proppant.

In Block 304, using an ML algorithm applied to a first portion of the training data set, a collection of individually trained ML models are generated. Each individually trained ML model is generated based on one of the sets of initial model parameters. For example, the training data set may include 90% of the data available and the rest is used as the validation data set for the ML model ranking. Each model has same feature values and target values. However, the initial guesses of model parameters are different. Further, an ANN model structure is determined. Specifically, the ANN model structure includes a number of layers and a number of nodes of each layer. Based on the loss values of the training data set, a plurality of models is selected.

In Block 306, a model performance of each trained model is calculated by comparing the difference between a validation data set and a respective predicted well production data of the individually trained ML models, and the order of the individually trained ML models is generated. For example, the validation data set may include the remaining 10% of the data that are not included in the training data set. Due to the small number of production wells contributing to the training data set, the predicted well production data may vary from one individually trained ML model to another individually trained ML model. In one or more embodiments, determining the given order is based on a loss function representing a mean squared error (MSE) between the validation data set and respective predicted well production data of individually trained ML models.

In Block 308, top-ranked individually trained ML models are selected based on the ranking. For example, a determined number of the highest ranked individually trained ML models may be selected.

In Block 310, a sensitivity study is performed to constrain the selected ML models by fixing the parameters with the representative values. In one or more embodiments, parameters such as the PVT window, a resource density, a total organic carbon (TOC), a water saturation, proppant per foot, proppant size ratio are fixed parameters, with their values averaged, for all the wells for each PVT window. Only the perforated well length is kept variable (as the only variable parameter), which is set to vary within the range of interest. The sensitivity study examines uncertainties in a ML model that affect the ML model's overall uncertainty. It determines what different values for an independent parameter can do to affect a specific dependent parameter, given a particular set of assumptions. In one or more embodiments, only the models that predict the increase in well performance when the well length increases are selected for the next step. That is, a subset of the ML models from the top-ranked ML models is selected based on the variable parameter of perforated well length. Other top ranked ML models that do not meet this criterion are discarded.

In Block 312, individual predicted well production data are generated using the geological, completion, and petrophysical data of interest as input to the constrained ML models. In one or more embodiments, the same observed well production data are used by the individually trained ML models.

In Block 314, a final predicted well production data is generated based on the individual predicted well production data that includes only the top ranked ML models that satisfied the physical constrain criteria. In one or more embodiments, the final predicted well production data is generated by averaging the individual predicted well production data. For example, the predicted production flow rates generated from the top-ranked individually trained ML models are averaged to generate the final predicted production flow rate.

FIGS. 4A-4D show an example in accordance with one or more embodiments. The example shown in FIGS. 4A-4D is based on the system and method described in reference to FIGS. 1-3 above. In particular, the example relates to generating ML model without significant amount of available data in the training data set by incorporating a simple physical constraint. For example, for a newly developed unconventional gas reservoir, it is not uncommon to have data from less than 100 wells.

For a relatively small size of data set, the overfitting is an issue for machine learning (ML) techniques. In a general sense, a ML model may underfit or overfit the training data set. As an example, consider a training data set that is generated by adding small random errors into a second-order polynomial function. The use of a linear function to fit the data introduces a systematic error, or bias, and underfit the data because the linear function does not have enough freedom. On the other hand, three or higher order polynomials fit the data more precisely, but introduce significant fluctuations between the two adjacent data points used for training. The fluctuations are referred to as variance that reduces the predictability of the trained model. Seeking the balance between bias and variance is an important issue for ML applications.

A widely used method to deal with overfitting is referred to as the bagging method and works as follows. For a given data set with the number of data points (i.e., size) N, a subset of n≤N data points is selected from the data set and used to train a ML model. Note that the same data point may occur more than one time in each selected data set because of the random selection process. Repeat the above procedure for a number of times corresponding to different selected data sets. Finally, the predictions of these trained ML models are averaged as the final prediction. The bagging generally results in much more reliable prediction results.

However, the bagging method does not work for a small data set available for predicting well production, simply because the data set is too small to be further divided into multiple data sets required by the bagging method. The example below describes a method to train the ML model for predicting the well production and has the same advantage of the bagging method in terms of overcoming the overfitting issue but without requiring dividing the data set.

FIG. 4A shows an artificial neural network (ANN) (410) as a particular type of ML model (referred to as the ANN model) in ML algorithms. ANN (410) is a mathematical model that simulates the structure and functionalities of biological neural networks. In this context, the ANN (410) is also referred to as the ANN model (410). The basic building blocks of the ANN (410) are artificial neurons (or neuron nodes depicted as circles in FIG. 4A, e.g., neuron nodes (411a, 412a, 412b, 413a)) that are connected to each other and process information flowing through the connections (depicted as arrows in FIG. 4A, e.g., connections (412, 412c, 413b)). The ANN (410) includes three different types of layers: input layer (411), hidden layers (412a, 412b) and output layer (413). Each node in the input layer (411) corresponds to a feature (or an input-data type) of the ML model. Thus, the number of nodes (e.g., 3) in the input layer (411) is the same as the number of features in the ML model. The number of hidden layers (e.g., 2) may be one or more. An ANN with more than one hidden layer, such as the ANN (410), is referred to deep learning network. The output layer (413) corresponds to the calculated result, or the output of the ML model.

In the mode of forward calculation or prediction, the node value in an ANN (410) is determined from the transformation of the summation of weighed node values from the previous layer. Each connection shown in FIG. 4A has a weight. The transformation is performed through an activation function.

A data set to train the ANN model (410) includes data point values for both input layer (411) and output layer (413). The data point values may correspond to geological, completion, petrophysical and production data. For a small data set (e.g., data points from less than 100 wells), approximately 10% of the data points in the data set is reserved for constraining model training process as the validation data set, which will be discussed later. The reserved data points are selected throughout the data range of interest and are not directly used for model training.

The training process is essentially the determination of unknown model parameters, such as weights, to match the prediction results with the observed target values (e.g., well production rate) using an optimization procedure. The distance between the predictions made by the ANN model (410) and the actual known values is measured by a loss function (LF) that is generally expressed as the mean squared error (MSE) between the prediction and the actual values. Thus, the training of the ANN model (410) is a process to minimize the LF. During the optimization process, the initial guesses of the model parameters are generally generated as random numbers. Non-uniqueness exists for the modeling training using a small data set (e.g., data points from less than 100 wells). More specifically, different combinations of model parameters may result in the same LF (or degree of matching against observations). These different combinations result from the use of different initial guesses of the model parameters.

As previously indicated, different trained models, resulted from the different initial guesses of the model parameters, may equally match the production data, but provide very different predictions. For each set of the initial guesses for model parameters, the trained model is referred to as an individual model. The individual models are collectively used to predict well performance as described below.

Firstly, multiple individual models are generated by using different and non-correlated sets of initial guesses of the model parameters. The entire value space of model parameters is sampled as the initial guesses to generate a large number (e.g., more than 1000) of individual models that capture relevant range of model behavior.

Secondly, the individual models are ordered based on the data points reserved for model constraining, or the validation data set. The given order depends on the prediction errors of the reserved data points. The prediction error is represented by the mean squared error (MSE). The lower the MSE, the higher the ranking. The highly ranked individual models have relatively high possibilities to provide more reliable model prediction.

Thirdly, a sensitivity study will be conducted with one variable changing from its minimum to its maximum while other input variables remain constant. The results are compared against a physical rule, for example, as the perforated well length increases, the overall production shouldn't decrease. The models generating results conforming to this rules are kept and those violating the rule are discarded.

Fourthly, the final trained model is generated by assembling. Specifically, a number of individual models with high rankings (e.g., top 50) are selected and averaged as the final trained model. To make a model prediction of well production, prediction results from these selected high ranking individual models are averaged as the final model prediction.

A case study is presented in FIGS. 4B-4D to demonstrate the efficacy of the final model prediction. The case study focuses on an organic-rich, yet low-clay content, tight carbonate source rock reservoir. Data is available from about 40 wells with slick water as fracturing fluid and includes geological information (e.g., thickness of producing formation), petrophysical properties (e.g., vertically averaged porosity, water saturation and total carbon content (TOC)), and completion parameters for hydraulic (e.g., number of stages, number of clusters per stage, total perforated well length, amount of proppant per perforated well length, amount of slurry per perforated well length, and the ratio of amount of 100 mesh proppant to the total amount of proppant). For each well, the linear flow parameter (LFP*), an indicator of well production, is available. Based on the available data, a ML model is generated for predicting LFP*. In this case study, approximately 40 data points for LFP* exist in the training data set. In other words, the training data set is a small data set.

Based on the available data, the ML features include PVT Window, resource density, total organic carbon (TOC), water saturation, perforated well length, proppant per foot, and proppant size ratio (defined as the ratio of amount of 100 mesh sand to the total amount of proppant). The PVT windows include wet gas window (WGW), gas condensate window (GCW), and volatile oil window (VOW). The resource density is defined as the formation net thickness multiplied by porosity and by hydrocarbon saturation (or one minus water saturation).

An ANN with one hidden layer that has 4 nodes is used for the study. Then 1,000 individual models are generated with different initial guesses of the model parameters and by matching the data. Three data points are reserved for ranking the individual models based on the prediction errors of the reserved data. The prediction error is represented by the mean squared error (MSE). The lower the MSE, the higher the ranking. The top 50 individual models are selected.

To make model predictions, LFP* prediction results from each of the top ranking 50 individual models are averaged as the final model prediction. FIGS. 4B-4D illustrate the reliability of the final ML model prediction. FIG. 4B shows the sensitivity analysis result for a relative perforated length, or the impact of the relative perforated length (plotted along the horizontal axis) on LFP* (plotted along the vertical axis) while keeping all the other parameters (except the relative perforated length) unchanged. The sensitivity study results for the well length that are the averaged curves for all the kept models under the condition that only the well length allows to change for each PVT window. The LFP* mostly linearly increases with relative perforated length.

FIG. 4C presents the sensitivity analysis result for the two model prediction results from two independent experiments following the presented ML model prediction procedure. The results are similar. In the model predictions, we kept all the parameters unchanged for a given PVT window except the relative TOC. In the figure, the relative TOC is defined as the difference between TOC and the minimum TOC that is divided by the difference between the maximum and minimum TOCs. Thus, the relative TOC ranges from zero to one. The relative LFP* (plotted along the vertical axis) refers to the LFP* divided by its observed maximum value of all the wells. The LFP* initially increases with the relative TOC for WGW, GCW, and VOW. However, the LFP* slightly decreases for WGW wells at 60% of relative TOC.

Embodiments provide the following advantages: (1) predicting well performance using machine learning techniques without overfitting issues, (2) providing reliable machine learning model using a small training data set, (3) constraining the selected models with simple physics constrains, so the results are conforming to all known physics rules/laws, and (4) averaging multiple machine learning models to improve prediction reliability without needing multiple training data sets.

Embodiments disclosed herein may be implemented on any suitable computing device, such as the computer system shown in FIG. 5. Specifically, FIG. 5 is a block diagram of a computer system (500) used to provide computational functionalities associated with described algorithms, methods, functions, processes, flows, and procedures as described in the instant disclosure, according to an implementation. The illustrated computer (500) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (500) may include a computer that includes an input device, such as a keypad, keyboard, touch screen, or other device that can accept user information, and an output device that conveys information associated with the operation of the computer (500), including digital data, visual, or audio information (or a combination of information), or a GUI.

The computer (500) can serve in a role as a client, network component, a server, a database or other persistency, or any other component (or a combination of roles) of a computer system for performing the subject matter described in the instant disclosure. The illustrated computer (500) is communicably coupled with a network (510). In some implementations, one or more components of the computer (500) may be configured to operate within environments, including cloud-computing-based, local, global, or other environment (or a combination of environments).

At a high level, the computer (500) is an electronic computing device operable to receive, transmit, process, store, or manage data and information associated with the described subject matter. According to some implementations, the computer (500) may also include or be communicably coupled with an application server, e-mail server, web server, caching server, streaming data server, business intelligence (BI) server, or other server (or a combination of servers).

The computer (500) can receive requests over network (510) from a client application (for example, executing on another computer (500) and responding to the received requests by processing the said requests in an appropriate software application. In addition, requests may also be sent to the computer (500) from internal users (for example, from a command console or by other appropriate access method), external or third-parties, other automated applications, as well as any other appropriate entities, individuals, systems, or computers.

Each of the components of the computer (500) can communicate using a system bus (570). In some implementations, any or all of the components of the computer (500), both hardware or software (or a combination of hardware and software), may interface with each other or the interface (520) (or a combination of both) over the system bus (570) using an application programming interface (API) (550) or a service layer (560) (or a combination of the API (550) and service layer (560). The API (550) may include specifications for routines, data structures, and object classes. The API (550) may be either computer-language independent or dependent and refer to a complete interface, a single function, or even a set of APIs. The service layer (560) provides software services to the computer (500) or other components (whether or not illustrated) that are communicably coupled to the computer (500). The functionality of the computer (500) may be accessible for all service consumers using this service layer. Software services, such as those provided by the service layer (560), provide reusable, defined business functionalities through a defined interface. For example, the interface may be software written in JAVA, C++, or other suitable language providing data in extensible markup language (XML) format or other suitable format. While illustrated as an integrated component of the computer (500), alternative implementations may illustrate the API (550) or the service layer (560) as stand-alone components in relation to other components of the computer (500) or other components (whether or not illustrated) that are communicably coupled to the computer (500). Moreover, any or all parts of the API (550) or the service layer (560) may be implemented as child or sub-modules of another software module, enterprise application, or hardware module without departing from the scope of this disclosure.

The computer (500) includes an interface (520). Although illustrated as a single interface (520) in FIG. 5, two or more interfaces (520) may be used according to particular needs, desires, or particular implementations of the computer (500). The interface (520) is used by the computer (500) for communicating with other systems in a distributed environment that are connected to the network (510). Generally, the interface (520 includes logic encoded in software or hardware (or a combination of software and hardware) and operable to communicate with the network (510). More specifically, the interface (520) may include software supporting one or more communication protocols associated with communications such that the network (510) or interface's hardware is operable to communicate physical signals within and outside of the illustrated computer (500).

The computer (500) includes at least one computer processor (530). Although illustrated as a single computer processor (530) in FIG. 5, two or more processors may be used according to particular needs, desires, or particular implementations of the computer (500). Generally, the computer processor (530) executes instructions and manipulates data to perform the operations of the computer (500) and any algorithms, methods, functions, processes, flows, and procedures as described in the instant disclosure.

The computer (500) also includes a memory (580) that holds data for the computer (500) or other components (or a combination of both) that can be connected to the network (510). For example, memory (580) can be a database storing data consistent with this disclosure. Although illustrated as a single memory (580) in FIG. 5, two or more memories may be used according to particular needs, desires, or particular implementations of the computer (500) and the described functionality. While memory (580) is illustrated as an integral component of the computer (500), in alternative implementations, memory (580) can be external to the computer (500).

The application (540) is an algorithmic software engine providing functionality according to particular needs, desires, or particular implementations of the computer (500), particularly with respect to functionality described in this disclosure. For example, application (540) can serve as one or more components, modules, applications, etc. Further, although illustrated as a single application (540), the application (540) may be implemented as multiple applications (540) on the computer (500). In addition, although illustrated as integral to the computer (500), in alternative implementations, the application (540) can be external to the computer (500).

There may be any number of computers (500) associated with, or external to, a computer system containing computer (500), each computer (500) communicating over network (510). Further, the term “client,” “user,” and other appropriate terminology may be used interchangeably as appropriate without departing from the scope of this disclosure. Moreover, this disclosure contemplates that many users may use one computer (500), or that one user may use multiple computers (500).

In some embodiments, the computer (500) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for predicting well production of a reservoir, comprising:
obtaining a training data set for training a machine learning (ML) model, wherein the ML model generates predicted well production data based on geological, completion, and petrophysical data of interest, wherein the training data set comprises historical well production data and corresponding geological, completion, and petrophysical data;
selecting an artificial neural network (ANN) model structure, the model structure including a number of layers and a number of nodes of each layer;
generating, using an ML algorithm applied to the training data set, a plurality of individually trained ML models, wherein each individually trained ML model is generated based on one of a plurality sets of initial model parameters and selecting the plurality of individually trained ML models based on loss values of the training data set;
calculating a model performance of each trained model by evaluating a difference between a model prediction and a well performance data,
determining, based on the model performance, an order of individually trained ML models based on both the loss value of the training data set and the loss values of a validation data set and selecting, based on the order, a plurality of top-ranked individually trained ML models;
constraining the plurality of top-ranked individually trained ML models using one or multiple known physical rules and selecting a subset of the top-ranked individually trained ML models that are based on a sensitivity analysis including a perforated well length rule;
generating, using the geological, the completion, and the petrophysical data of interest as input to the constrained models, a plurality of individual predicted well production data; and
generating, based on the plurality of individual predicted well production data, a final predicted well production data.

2. The method of claim 1,
wherein fixed parameters examined in the sensitivity analysis are a pressure/volume/temperature window, a resource density, a total organic carbon (TOC), a water saturation, proppant per foot, and a proppant size ratio, and
wherein a single variable parameter is a perforated well length.

3. The method of claim 2, wherein only a plurality of selected models that predict increase in well performance with the increase of the perforated well length are used to generate the plurality of individual predicted well production data.

4. The method of claim 1, wherein the set of initial model parameters correspond to weights associated with connections between neural nodes of the ANN.

5. The method of claim 1, wherein the set of initial model parameters comprises randomly generated model parameter values.

6. The method of claim 1,
wherein the reservoir is a tight reservoir; and
wherein the training data set comprises the historical well production data and corresponding geological, completion, and petrophysical data that are obtained from less than 100 production wells of the reservoir.

7. The method of claim 1, wherein generating the final predicted well production data comprises averaging the plurality of individual predicted well production data.

8. The method of claim 1, wherein the ML algorithm is applied to the training data set to generate a set of trained model parameters for each of the plurality of individually trained ML models.

9. The method of claim 1, wherein generating the order of the plurality of individually trained ML models is based on a loss function representing a mean squared error (MSE) for the validation data set of the plurality of individually trained ML models.

10. The method of claim 1, wherein constraining the plurality of individually trained ML models is based on a physics rule or multiple rules of the plurality of individually trained ML models.

11. A non-transitory computer readable medium storing instructions executable by a computer processor, the instructions comprising functionality for, comprising:
obtaining a training data set for training a machine learning (ML) model, wherein the ML model generates predicted well production data based on geological, completion, and petrophysical data of interest, wherein the training data set comprises historical well production data and corresponding geological, completion, and petrophysical data;
selecting an artificial neural network model structure, the model structure including a number of layers and a number of nodes of each layer;
generating, using an ML algorithm applied to the training data set, a plurality of individually trained ML models, wherein each individually trained ML model is generated based on one of a plurality sets of initial model parameters and selecting the plurality of individually trained ML models based on loss values of the training data set;
calculating a model performance of each trained model by evaluating a difference between a model prediction and a well performance data,
determining, based on the model performance, an order of individually trained ML models based on both the loss value of the training data set and the loss values of a validation data set and selecting, based on the order, a plurality of top-ranked individually trained ML models;
constraining the plurality of top-ranked individually trained ML models using one or multiple known physical rules and selecting a subset of the top-ranked individually trained ML models that are based on a sensitivity analysis including a perforated well length rule;
generating, using the geological, completion, and petrophysical data of interest as input to the constrained models, a plurality of individual predicted well production data; and
generating, based on the plurality of individual predicted well production data, a final predicted well production data.

12. The non-transitory computer readable medium of claim 11, wherein fixed parameters examined in the sensitivity analysis are a pressure/volume/temperature window, a resource density, a total organic carbon (TOC), a water saturation, proppant per foot, proppant size ratio and variable parameter is a perforated well length.

13. The non-transitory computer readable medium of claim 11, wherein only a plurality of selected models that predict increase in well performance with the increase of the perforated well length are used to generate the plurality of individual predicted well production data.

14. The non-transitory computer readable medium of claim 11,
wherein the ML model comprises an artificial neural network (ANN), and
wherein the initial model parameters correspond to weights associated with connections between neural nodes of the ANN.

15. The non-transitory computer readable medium of claim 11, wherein each of the plurality sets of initial model parameters of the ML model comprises randomly generated model parameter values.

16. The non-transitory computer readable medium of claim 11,
wherein a reservoir is a tight reservoir; and
wherein the training data set comprises the historical well production data and the corresponding geological, completion, and petrophysical data that are obtained from less than 100 production wells of the reservoir.

17. The non-transitory computer readable medium of claim 11, wherein generating the final predicted well production data comprises averaging the plurality of individual predicted well production data.

18. The non-transitory computer readable medium of claim 11, wherein the ML algorithm is applied to the training data set to generate a set of trained model parameters for each of the plurality of individually trained ML models.

19. A system comprising:
a tight reservoir;
a data repository storing a training data set for training a machine learning (ML) model, wherein the training data set comprises historical well production data and corresponding geological, completion, and petrophysical data; and
an analysis and modeling engine comprising functionality for:
obtaining the training data set for training ML model, wherein the ML model generates predicted well production data based on geological, completion, and petrophysical data of interest, wherein the training data set comprises the historical well production data and corresponding geological, completion, and petrophysical data;
selecting an artificial neural network model structure, the model structure including a number of layers and a number of nodes of each layer;
generating, using an ML algorithm applied to the training data set, a plurality of individually trained ML models, wherein each individually trained ML model is generated based on one of a plurality sets of initial model parameters and selecting the plurality of individually trained ML models based on loss values of the training data set;
calculating a model performance of each trained model by evaluating a difference between a model prediction and a well performance data,
determining, based on the model performance, an order of individually trained ML models based on both the loss value of the training data set and the loss values of a validation data set and selecting, based on the order, a plurality of top-ranked individually trained ML models;
constraining the plurality of top-ranked individually trained ML models using one or multiple known physical rules and selecting a subset of the top-ranked individually trained ML models that are based on a sensitivity analysis including a perforated well length rule;
generating, using the geological, completion, and petrophysical data of interest as input to the constrained models, a plurality of individual predicted well production data; and
generating, based on the plurality of individual predicted well production data, a final predicted well production data.

20. The system of claim 19, wherein fixed parameters examined in the sensitivity analysis are a pressure/volume/temperature window, a resource density, a total organic carbon (TOC), a water saturation, proppant per foot, proppant size ratio and variable parameter is a perforated well length.
